(19) United States
(12) Patent Application Publication
(10) Pub. No.: US 2005/0008149 A1
(43) Pub. Date: Jan. 13, 2005

(54) Programmable data processing apparatus for CCMP hardware implementation

(75) Inventors: Ming-Shiang Lai, Taipei (TW); Chih-Pen Chang, Taipei (TW)

Correspondence Address: BRUCE H. TROXELL, SUITE 1404, 5205 LEESBURG PIKE, FALLS CHURCH, VA, 22041, US

(73) Assignee: ALi Corporation

(21) Appl. No.: 10/760,393

(22) Filed: Jan. 21, 2004

(30) Foreign Application Priority Data
Jun. 10, 2003 (TW) 92115620

(51) Int. Cl. H04K 1/00

(52) U.S. Cl. 380/28

(57) ABSTRACT

The present invention relates to a programmable data processing apparatus that can minimize the extent of hardware modification by using a storage unit for storing the mutable fields of the WLAN encryption standard, while the encryption standard used in wireless local area network (WLAN) is varied. The programmable data processing apparatus comprises: a first storage unit, which stores at least an auxiliary data, wherein the auxiliary data stored in the first storage unit can be renew from outside when the encryption standard is varied; a reader, coupled to the first storage unit, which is used for receiving an index so as to read a corresponding auxiliary data from the first storage unit; a processor, coupled to the reader, for receiving the auxiliary data and a data signal, wherein, the processor will processes the data signal according to the auxiliary data so as to output a processed signal.

### BACKGROUND OF THE INVENTION

(a). Field of the Invention

The present invention relates to a programmable data processing apparatus, more particularly, to a programmable data processing apparatus that can minimize the extent of hardware modification while the encryption standard used in wireless local area network (WLAN) is varied.

(b). Description of the Prior Arts

Nowadays, along with the progress of wireless telecommunication technology, all kinds of products, such as cellular phone, notebook computer, personal digital assistant (PDA), etc., have fulfilled humans' desire for wireless communication that not only enables users to be able to free from the constraint of corded phone, but also gives users more freedom and, the same time, shortens the distance between people.

Ever since the Institute of Electrical and Electronic Engineers (IEEE) launched the wireless standard, there have been fears about its security. Broadcasting data packets over a 1,500 m radius is different from sending them over cables. The problem with broadcasting data over a relatively wide area is that smart people with the right equipment can intercept the signal and further uses the intercepted signal to hack the network, such as forging, tampering, etc. Security experts are concerned at the disparity between the amount of wireless network activity in the corporate community and the low level of awareness of the vulnerability of radio local area networks (LANs). In order to enhance the security features provided in a wireless LAN (WLAN) system, the IEEE has established an encryption standard protocol adopting advance encryption standard (AES), that is, the IEEE 802.11i counter mode with CBC-MAC protocol (CCMP), wherein the 802.11i specification defines a new encryption method based on the advanced encryption standard (AES). Nevertheless, In order to enhance the security features provided in a WLAN system, more tests and experiments are needed before the IEEE 802.11i specification is produced. In the IIEEE 802.11i specification, partial field of the frame header of the MAC service data unit (MSDU) used as encrypting/decrypting parameter under the CCMP mode is defined to be mutable fields. During a CCMP encryption process, in response to the aforesaid condition that the field of the mutable fields will be discarded or will be set to value 0.

Please refer to FIG. 1, which is a architecture diagram of CCMP. As seen in FIG. 1, a signal received by a CCM control logic 3 is encrypted using two AES encryptors 5 according to standard encryption steps, then the encrypted signal is being sent out. However, along with the variation of the specification used in the WLAN, the data format will change accordingly. Thus, the hardware design of the CCM control logic 3 constantly requires to be updated, especially the portion for receiving data signal.

In the fierce competition of the Hi-tech industry, time is the key element to succeed. To succeed the competition, industry can not wait until the specification is accomplished to begin the relating research and development. For carrying on the research and development synchronized with defining the specification, the field of the mutable fields is discarded or set to 0, moreover, the aforesaid field is also used as CCM additional authenticated data. In this regard, a slight variation in the specification will cause a redesign of hardware so as to conform to the requirement of the specification, which is a waste of time and also is inefficient. Therefore, while the specification is still undetermined, a hardware architecture that can be redesigned over and over is needed.

### SUMMARY OF THE INVENTION

The primary object of the present invention is to provide a flexible hardware architecture that can minimize the extent of hardware modification while the specification is varied

In order to achieve the foregoing object, the programmable data processing apparatus of the present invention comprises:
a first storage unit, which stores auxiliary data needed in a encryption algorithm for data processing, wherein, when the encryption algorithm is varied, the auxiliary data stored in the first storage unit can be updated correspondently from outside.

A reader, coupled to the first storage unit for receiving an index so as to read an auxiliary data from the first storage unit according to the index. and
a processor, coupled to the reader for receiving a data signal corresponding to the index so as to process the data signal according to the auxiliary data corresponding to the index.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

FIG. 1 is an architecture diagram of CCMP.

FIG. 2 is an architecture diagram of the present invention.

FIG. 3 is an embodiment of the present invention.

FIG. 4 is a flowchart depicting the present invention.

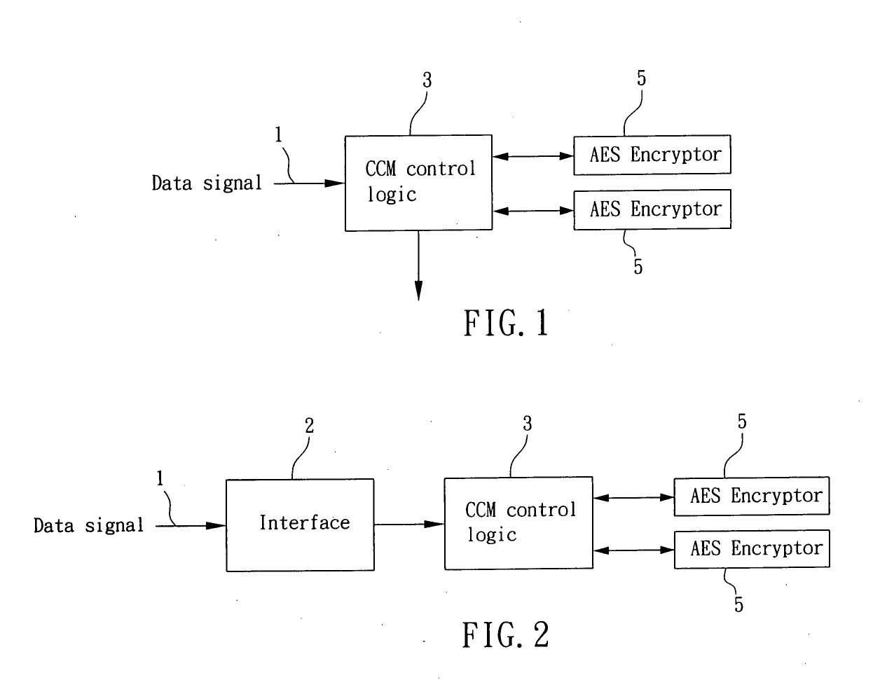

### DETAILED DESCRIPTION OF THE PRESENT INVENTION

The objects, spirits and advantages of the preferred embodiments of the present invention will be readily understood by the accompanying drawings and detailed descriptions, wherein:

Please refer to FIG. 2,

Please refer to FIG. 2, which is an architecture diagram of the present invention. The spirit of the present invention is to provide an interface 2 so that a storage unit can be used to record the field variation of the mutable fields. When the specification standard is varied, one can simply renew the data stored in the storage unit and the data signal 1 can still be fed into the CCM control logic 3, after being processed using the interface 2, to accomplish the object of field variation for conforming with the new specification, without the need to fix the CCM control logic 3, not to mention the interface 2. Therefore, a great deal of time and effort spent for hardware design can be saved.

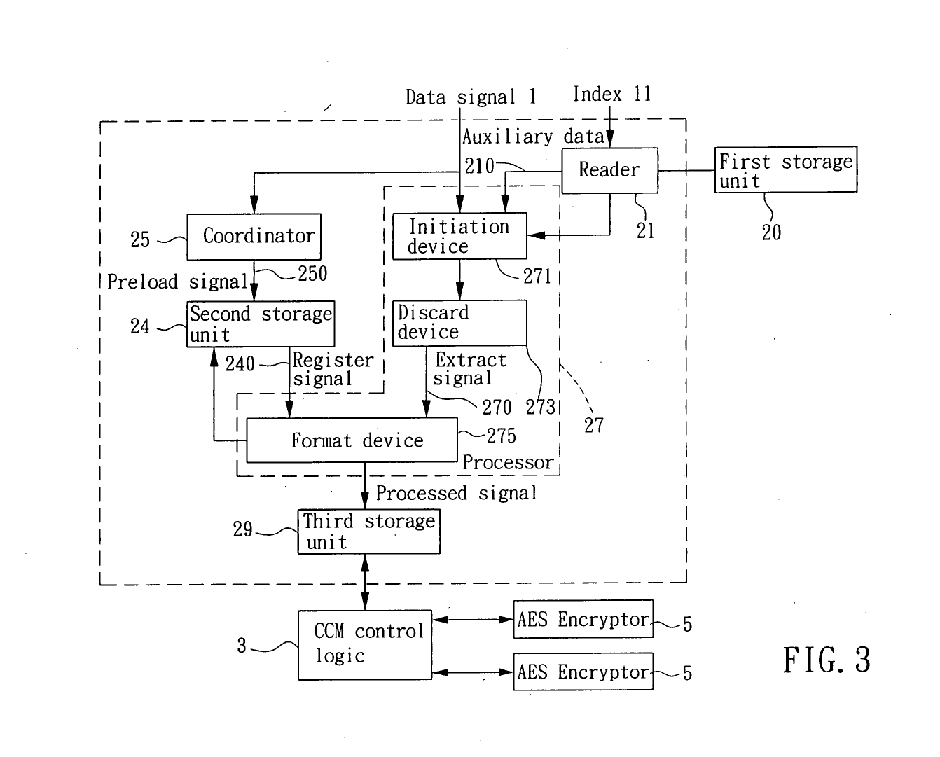

Please refer FIG. 3, which is an embodiment of the present invention, comprising:
a first storage unit 20, which stores at least an auxiliary data, wherein the auxiliary data 210 stored in the first storage unit 20 can be renew from outside when the encryption standard is varied.
a reader 21, connected to the first storage unit 20, which is used for receiving an index 11 so as to read a corresponding auxiliary data 210 from the first storage unit 20 using a look-up table in accordance to the index 11.
a second storage unit 24, for receiving a preload signal 250 to register the input data and outputting a register signal 240, wherein the second storage unit 24 is mainly used for registering the inputted data, moreover, the preload signal 250 provided by a coordinator 25 inside the interface is used to replenish the frame header with data needed in the encryption process, such as header length.
a processor 27, coupled to the reader 21 and the second storage unit 24 for receiving the auxiliary data 210, the register signal 240 and the data signal 1. The processor 27 processes the data signal 1 according to the auxiliary data 210 and outputs a processed signal, the same time, feeds the portion of data exceeding a process length to the second storage unit 24 for registering. The processor 27 starts a discarding operation or an initialization operation to a portion of the data signal 1 according to the auxiliary data. Thus, the processor further comprises:
an initialization device 271, connecting to the reader 21, which is used for setting partial bits of the data signal 1 to a specified value according to the auxiliary data 210. The specified value can be 0 or 1 depending on the requirement of the specification, and usually the value is set to be 0. In reality, the initialization device can be a bit mask, i.e. the auxiliary data 210 indicates the address of designated bits to be 0, others to be 1, that the setting the partial bits of the data signal 1 to a specified value can be accomplished by operating a logical AND on the auxiliary data 210 and the data signal 1.
a discard device 273, connecting to the reader 21, which is used for discarding partial bits of the data signal 1 according to the auxiliary data 210. The discard device 273 will discard the bits that are not necessary for the encryption process or the bits that are not used in the specification, and fill the vacant position successively forward with the remaining bits, and if the remaining bits are not enough to fill the vacant positions, the addresses of the aforesaid vacant positions are filled with 0.
a format device 275, receiving a first input of an extract signal 274 processed by either the initialization device 271 or the discard device 273 and a second input of the second storage unit 24, wherein the format device will format the first input and the second input according to the process length so as to output a processed signal 270, moreover, the data exceeding the process length will be send to the second storage unit 24 for registering. The format device 275 will prioritize the second input coming from the second storage unit 24, that is, the format device 275 will prioritize and put in front the register signal 240 inputted from the second storage unit 24, then will adhere the extract signal 274 received from the first input to the register signal. The output of the format device 274 has a length limit that the portion exceeding the process length will be send to the second storage unit 24 for registering and waiting to be outputted the next time.

In the present embodiment, the input unit and output unit of the CCM control logic are both 128 bits, but the transmission volume of the data signal 1 is 32 bits per transmission. Under the circumstance, a third storage unit 29 is required for used as interface. The third storage unit 29 is connected to the processor 27 for receiving the processed signal 270, and output the processed signal to a posterior circuit when the processed signal is accumulated to a designated amount of bits, moreover, the posterior circuit is the CCM control logic 3. In the present embodiment, the designated amount of bits is 128 bits, that is, the third storage unit 29 will not transmit data to the CCM control logic 3 until the total amount of data stored in the third storage unit reached 128 bits.

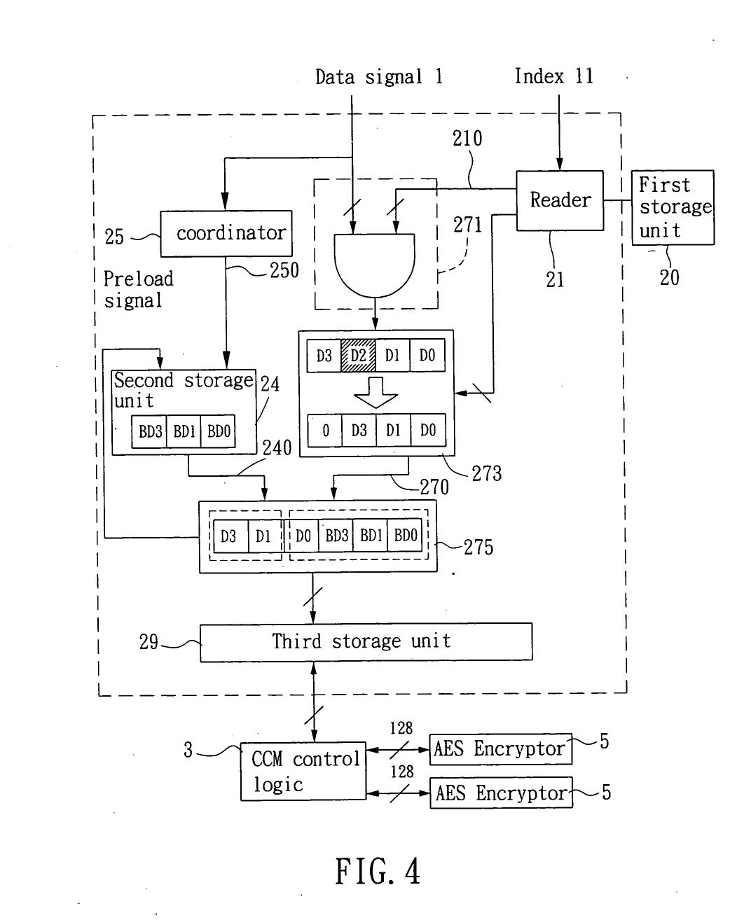

Please refer to FIG. 4, which is a flowchart depicting the present invention using the embodiment of FIG. 3. The transmission volume of the data signal 1 is 32 bits per transmission, i.e. 4 bytes and can be represented using D0, D1, D2, and D3. While the data signal 1 is being transmitted, an index 11 is also being inputted into the reader 21 simultaneously so that the reader 21 can access the auxiliary data 210 corresponding to the index 11 from the first storage unit 20. In addition, data signal 1 will also be send to the coordinator 25 so that the preload signal 250 is sent to the second storage unit 24 by the coordinator 25, wherein the second storage unit 24 is a 3-byte register that can be represented successively using BD0, BD1, and BD2. Thus, the data signal 1 first is fed into the processor 27, wherein the initialization device 271 will set the value of a designated bit to be 0 and the discard device 273 will discard other designated bit that are both according to the auxiliary data 210 accessed by the reader 21, e.g. D2 is discarded, therefore, the value stored in D3 is mapped and moved to D2 and set the value of D3 to 0. Afterward, both the register signal 240 coming from the second storage unit 24 and the extract signal 274 which is the resulting signal of the data signal 1 after processed by the initialization device 271 and the discard device 273 are loaded into the format device 275, wherein the format device 275 will prioritize and put in front the register signal 240 inputted from the second storage unit 24, then adhere the extract signal 274 to the register signal 240, moreover, the processed signal 270 having a specified process length (which is 4 bytes in the present embodiment) is outputted by the format device 274 and the portion of data exceeding the process length will be send to the second storage unit 24 for registering and waiting to be outputted the next time. As seen in FIG, 4, BD0, BD1, BD2 and D0 can be the processed signal that are outputted by the format device 275, and D1, D3 exceeding the process length will be send back to the second storage unit 24 for registering, furthermore, the D1 and D3 sent by to the second storage unit 24 will become BD0, BD1 and BD2 having priority for the next transmission. A third storage unit 29 is needed for registering the signal outputted from the processor 27 until 128 bits of data is accumulated, since the CCM control logic 3 controlling the encryption process receives and transmits data using 128 bits per transmission.

In this regard, no matter how the specification is varied, only the auxiliary data stored in the first storage unit 20 will require to be modified and no other design will need to be altered. Thus, while the specification is still in development, the reusable memory is usually employed as the first storage unit 20, such as the programmable read only memory (PROM), the erasable programmable read only memory (EPROM), or the electrically erasable programmable read only memory (EEPROM). On the other hand, when the produce is put on the market, for the object of cost-down, the read only memory (ROM) is commonly used as the first storage unit 20. In this way, a great deal of redesigning work caused by the variation of specification can be avoid.

The present invention is also applicable to another encryption standard: WiFi Protected Access of WiFi alliance.

While the present invention has been shown and described with reference to a preferred embodiment thereof, and in terms of the illustrative drawings, it should be not considered as limited thereby. Various possible modification, omission, and alterations could be conceived of by one skilled in the art to the form and the content of any particular embodiment, without departing from the scope and the sprit of the present invention.

1. a programmable data processing apparatus, comprising:
a first storage unit, which stores auxiliary data needed in a encryption algorithm for data processing, wherein, when the encryption algorithm is varied, the auxiliary data stored in the first storage unit can be updated correspondently from outside;
a reader, coupled to the first storage unit for receiving an index so as to read an auxiliary data from the first storage unit according to the index; and
a processor, coupled to the reader for receiving a data signal corresponding to the index so as to process the data signal according to the auxiliary data corresponding to the index.

2. The programmable data processing apparatus of claim 1, wherein the encryption algorithm is IEEE802.11i Counter-Mode/CBC-MAC Protocol (CCMP), and the data signal is a portion of MAC Service Data Unit (MSDU) of wireless local area network (WLAN).

3. The programmable data processing apparatus of claim 1, further comprising: a third storage unit coupled to the processor 27, for receiving a processed data signal from the processor, and output the processed signal to a posterior circuit when the processed signal is accumulated to a designated amount of bits

4. The programmable data processing apparatus of claim 3, wherein the designated amount of bits is 128 bits.

5. The programmable data processing apparatus of claim 1, wherein the first storage unit is a read only memory (ROM).

6. The programmable data processing apparatus of claim 1, wherein the first storage unit is a programmable read only memory (PROM).

7. The programmable data processing apparatus of claim 1, wherein the first storage unit is an erasable programmable read only memory (EPROM).

8. The programmable data processing apparatus of claim 1, wherein the first storage unit is an electrically erasable programmable read only memory (EEPROM).

9. The programmable data processing apparatus of claim 1, wherein the processor further comprising: an initialization device coupled to the reader, which is used for setting partial bits of the data signal to a specified value according to the auxiliary data corresponding to the index.

10. The programmable data processing apparatus of claim 9, wherein the specified value can be one of the following: 0 and 1.

11. The programmable data processing apparatus of claim 1, wherein the processor further comprising: a discard device coupled to the reader, which is used for discarding partial bits of the data signal according to the auxiliary data corresponding to the index.

12. The programmable data processing apparatus of claim 1, wherein the processor further comprising: a format device having a first input for inputting data and a second input for receiving a register signal coming from a second storage unit, wherein the format device will format the first input and the second input according to a process length so as to output a processed signal, moreover, the data exceeding the process length will be send to the second storage unit for registering.

13. The programmable data processing apparatus of claim 12, wherein the second storage unit connecting to the format device of the processor can receive a preload signal and the data exceeding the process length coming from the processor, wherein the forgoing inputted data is registered, and the register signal is outputted to the format device of the processor by the second storage unit.

14. The programmable data processing apparatus of claim 13, wherein the format device will prioritize the second input coming from the second storage.

15. The programmable data processing apparatus of claim 13, wherein the second storage unit is a register.
